(19) United States
(12) Patent Application Publication
(10) Pub. No.: US 2008/0033132 A1
(43) Pub. Date: Feb. 7, 2008

(54) Method for manufacturing a free flowing powder of a fluoropolymer and a free flowing powder manufactured according to said method

(75) Inventors: Michael Schlipf, Heidenheim (DE); Martin Metzger, Isny (DE)

Correspondence Address: Mr. Edward J. Timmer, P.O. Box 770, Richland, MI, 49083-0770, US

(73) Assignee: Elringklinger AG

(21) Appl. No.: 11/811,535

(22) Filed: Jun. 11, 2007

(30) Foreign Application Priority Data
Aug. 3, 2006 (DE) 10 2006 036 204.7

(51) Int. Cl. C08F 10/02; C08J 3/12

(52) U.S. Cl. 526/255; 241/3

(57) ABSTRACT

In order to provide a simple and economical method for the production of a flowable powder of a fluoropolymer, there is proposed a method for the production of a flowable powder of a fluoropolymer from a starting material in powder form, which contains at least one fluoropolymer material, which comprises the following method steps:
pressing the starting material in powder form into lumps;
crushing the lumps to form the flowable powder.

The present disclosure relates to the subject that has been disclosed in the German Patent Application No. 10 2006 036 204.7 of 3 Aug. 2006. The entire description of this earlier application is incorporated by reference into the present description.

The present invention relates to a method for the production of a flowable powder of a fluoropolymer. The present invention additionally relates to a flowable powder of a fluoropolymer produced according to this method.

Suspension fluoropolymers, in particular suspension PTFE and chemically modified suspension PTFE, are produced in batch processes in stirred-tank reactors in the presence of water. After polymerisation the aqueous phase is separated in several stages and the raw suspension polymerisate obtained is dried and ground.

The fluoropolymer powders produced according to this method, in particular PTFE powders and modified PTFE powders, have a powder density of 100 g/l to 700 g/l and an average grain size d₅₀ of approximately 5 μm to approximately 100 μm.

These PTFE powders can only be processed manually, e.g. using a scoop, because of poor flowability. Therefore, automatic processing in particular using automatic filling or apportioning devices is not possible.

The bulk density of such non-flowable powders varies over a wide range and changes very significantly as a result of external action such as movement, pressure or vibrating, for example. As a result, uniform filling of the press mould with subsequent homogeneous compaction of the powder during pressing becomes difficult. Non-homogeneous material properties in the end product or internal stresses after sintering can result.

A method for converting non-flowable PTFE powder or non-flowable modified PTFE powder into PTFE powder with good flowability is known from patent documents WO 98/41567 A1 and WO 98/41568 A1. In this method, working from a non-flowable powder, reactors working stepwise or continuously are used for granulation, in which water and an organic solvent not miscible with water as well as possibly a non-ionic surfactant are intensively stirred.

In another method a ground PTFE powder is mixed with an alcohol, preferably with isopropyl alcohol. This mixture is then homogenised to a kneadable mass, which is brought into a rod form by means of a special screen-type mill and applied directly centrally onto a vibration plate. The spiral-shaped contour of the vibration plate conveys the product to the outer edge of the plate, where it is removed. In this case, the vibration movement causes the originally rod-shaped particles to be converted into granular material. After a subsequent drying process, in which the alcohol is removed and the agglomerate consolidated, the product is in a flowable agglomerate form.

In a further known method, working from a ground PTFE powder, a mixture of water and a surface-active substance, e.g. a surfactant or glycol, is used to obtain a flowable agglomerate.

However, the aforementioned granulation processes have numerous disadvantages. Thus, in particular the use of solvents can result in the formation of explosive gas/air mixtures. The solvents used can cause health problems for the work force, particularly if these are toxic solvents, e.g. methylene chloride. The flowable product produced by means of these methods can be contaminated by embedded residues of surfactants. Costly drying processes are necessary to remove water, solvent and/or surfactant from the product. Moreover, the known granulation processes are often uneconomical because of the large number of process steps necessary.

It is an object of the present invention to provide a simple and economical method for the production of a flowable powder of a fluoropolymer.

This object is achieved according to the invention by a method for the production of a flowable powder of a fluoropolymer from a starting material in powder form, which contains at least one fluoropolymer material, wherein the method comprises the following method steps:
pressing the starting material in powder form into lumps;
crushing the lumps to form the flowable powder.

In this case, “lumps” should be understood to mean lumpy, band-shaped intermediate products that are generated by pressing the starting material in powder form.

The method according to the invention is a dry method, i.e. a dry granulation of the fluoropolymer without the addition of solvents or water/surfactant mixture.

Therefore, in the method according to the invention, all the disadvantages of the known granulation methods attributable to the use of solvents are removed, in particular the associated emission problems and the problem of a possible contamination of the end product by embedded residues of solvent constituents or additives.

The dry granulation method according to the invention is of particularly simple structure and comprises only few process steps, which is why it is particularly economical to implement.

The powder of a fluoropolymer obtained according to the method of the invention has a good flowability and can be easily apportioned by automatic devices in machines for further processing.

In principle, all machines that are typically used for the press processing of PTFE powders are suitable for further processing the powder produced according to the invention, i.e. for example: hydraulic presses, automatic and isostatic presses or ram extrusion.

The powder produced in this way is particularly suitable for processing by means of ram extrusion.

The electrostatic chargeability of the flowable powder can be negligible in comparison to the non-flowable starting material in powder form, which is why the risk of a contamination of the flowable end product is very small.

The starting material in powder form contains at least one preferably ground fluoropolymer material in powder form.

It is preferably provided that the starting material in powder form contains polytetrafluoroethylene (PTFE) or modified polytetrafluoroethylene as fluoropolymer material.

Both types of PTFE are produced by means of suspension polymerisation.

In this case, a “modified polytetrafluoroethylene” is a PTFE-like substance, wherein the molecular structure of the PTFE has been chemically modified as a result of a further, likewise perfluorinated, monomer being incorporated into the molecular chain besides TFE, so that the fluorine atoms of the PTFE are partially replaced by substituents.

The chemical composition and production of “modified PTFE” are described, for example, in patents EP 0 041 687 A1, EP 0 931 798 A1 or U.S. Pat. No. 6,013,700.

The PTFE or modified PTFE used as constituent of the starting material in powder form is preferably produced as a suspension PTFE or chemically modified suspension PTFE in batch processes in stirred-tank reactors in the presence of water, wherein after polymerisation the aqueous phase is separated in several stages and the raw suspension polymerisate obtained is dried and ground.

The starting material in powder form used for the method according to the invention preferably has a bulk density of approximately 100 g/l to approximately 700 g/l.

The flowable powder produced by means of the method according to the invention preferably has a bulk density of approximately 400 g/l to approximately 1600 g/l.

It is particularly favourable if the flowable powder has a higher bulk density than the starting material in powder form.

The fluoropolymer material of the starting material in powder form preferably has an average grain size d₅₀ of approximately 5 μm to approximately 100 μm.

The flowable powder produced by means of the method according to the invention preferably has an average grain size d₅₀ of approximately 300 μm to approximately 2500 μm.

It is particularly favourable if the flowable powder has a higher average grain size d₅₀ than the fluoropolymer material in the starting material in powder form.

In principle, it is possible to feed the starting material in powder form to a pressing device, in which the starting material is pressed to form lumps, simply by the action of gravity.

However, in a preferred configuration of the method according to the invention it is provided that the starting material in powder form is conveyed to such a pressing device by means of a worm device.

If such a pressing device has two opposing rollers, then the worm device for conveying the starting material in powder form preferably reaches into the gusset region between the opposing rollers.

The worm device preferably has a substantially vertical rotational axis.

In addition, the worm device is preferably operated at a speed of approximately 10 rpm to approximately 100 rpm.

The worm device can have a pitch that decreases in the transport direction of the worm device and/or a diameter that decreases in the transport direction of the worm device.

The transport chamber, in which the worm device is arranged, can have a smooth interior wall.

In a preferred configuration of the invention it is provided that the worm device is arranged in a transport chamber, which has at least one groove running in a spiral shape around the transport direction of the worm device to thus assist the feeding action of the worm device.

In the method according to the invention it can be provided that the starting material in powder form is pre-compacted before pressing, e.g. by means of a worm device conveying the starting material to the pressing device.

In addition, it can be provided that the starting material in powder form is at least partially deaerated before pressing.

In a preferred configuration of the method according to the invention it is provided that the starting material in powder form is pressed to form the lumps by means of at least one roller, in particular by means of one roller pair.

The roller or rollers is/are preferably operated with a specific contact force of approximately 1 kN/cm to approximately 10 kN/cm.

In addition, the roller or rollers is/are operated at a speed of approximately 3 rpm to approximately 10 rpm.

The rollers can be provided with a smooth rolling surface or also with a profiled rolling surface.

The rollers or at least the roller surfaces can be made of metal, thermoplastic or thermosetting plastic and/or of an elastomer.

The pressing of the dry mixture to form the lumps is preferably conducted so that the relative density of the lumps produced by pressing the starting material amounts to approximately 1.3 g/cm³ to approximately 2.1 g/cm³.

The lumps produced by pressing the starting material are preferably crushed by means of a mill.

A screen-type mill in particular can be used for this.

The mill is preferably operated at a speed of approximately 60 rpm to approximately 400 rpm.

Claim 26 relates to a flowable powder of a fluoropolymer, which is produced by a method according to the invention.

This flowable powder is suitable in particular for the production of PTFE semi-finished products by means of ram extrusion.

Preferred semi-finished products are rods, tubes or other extruded products with simple cross-sections.

Claim 28 is directed towards a polymer workpiece, which is produced from a flowable powder produced using the method according to the invention.

The following advantages can be achieved in particular by the dry granulation method according to the invention:

The bulk density of the starting material in powder form in the range of approximately 100 g/l to approximately 700 g/l is increased to the bulk density of the flowable powder in the range of approximately 400 g/l to approximately 1500 g/l.

At the same time, the powder is stabilised with respect to the bulk density, so that it has a substantially homogeneous bulk density, which allows a uniform filling of the press mould with subsequent homogeneous compaction of the flowable powder during pressing during the course of a further processing operation.

The grain size distribution of the flowable powder with agglomerates with an average grain size in the range of approximately 300 μm to approximately 2500 μm replaces

the grain size distribution of the ground fluoropolymer powder in the starting material with an average grain size of d₅₀ in the range of approximately 5 μm to approximately 100 μm.

The electrostatic chargeability is reduced by the dry granulation method according to the invention, as a result of which the risk of a dirt inclusion and separation during the subsequent processing of the flowable powder is reduced.

The economic efficiency and reproducibility of the subsequent further processing of the powder are improved because the flowable powder produced by the method according to the invention can be further processed automatically.

The increase in the bulk density as a result of the method according to the invention, a consequence of the granulation step, increases the economic efficiency in particular in the case of automatic press processing, and moreover allows the production of products with larger dimensions than is possible in the case of non-flowable powders and using the same press moulds.

Further features and advantages of the invention are the subject of the following description and the representation of exemplary embodiments in the drawings.

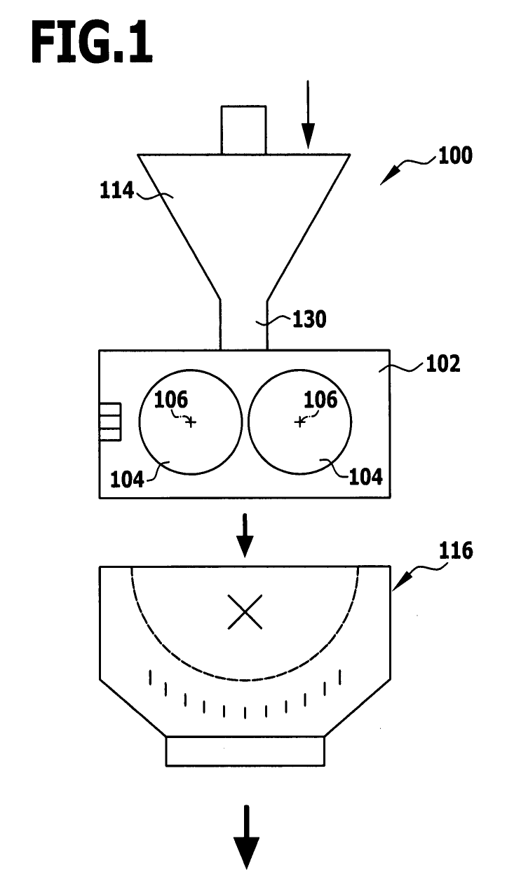

FIG. 1 is a schematic representation of a device for producing a flowable powder of a fluoropolymer from a starting material in powder form;

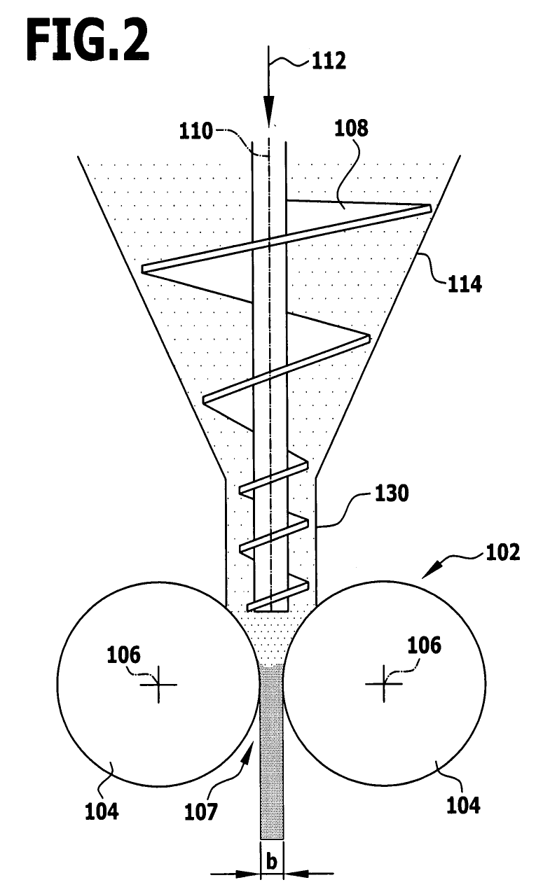

FIG. 2 is a schematic section through a pressing device of the device from FIG. 1, which comprises a pair of rollers, and a worm device conveying the starting material to the pressing device;

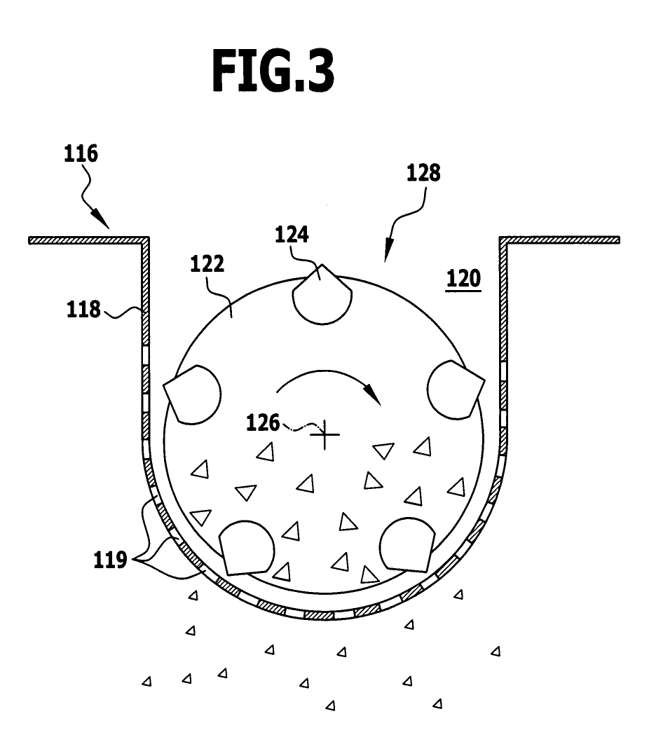

FIG. 3 is a schematic section through a screen-type mill, which crushes lumps produced by means of the pressing device from FIG. 2 to form the flowable powder;

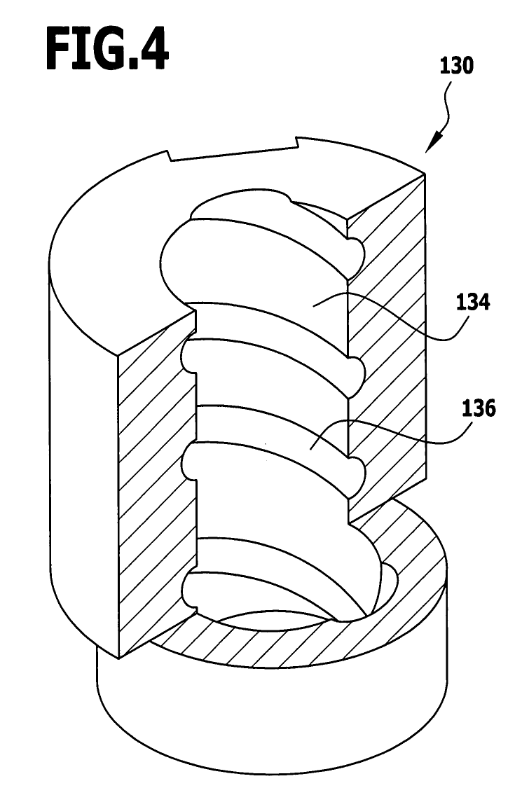

FIG. 4 is a perspective representation in partial section of a cylindrical transport chamber with a spiral-shaped groove for assisting the feeding action of the worm device; and

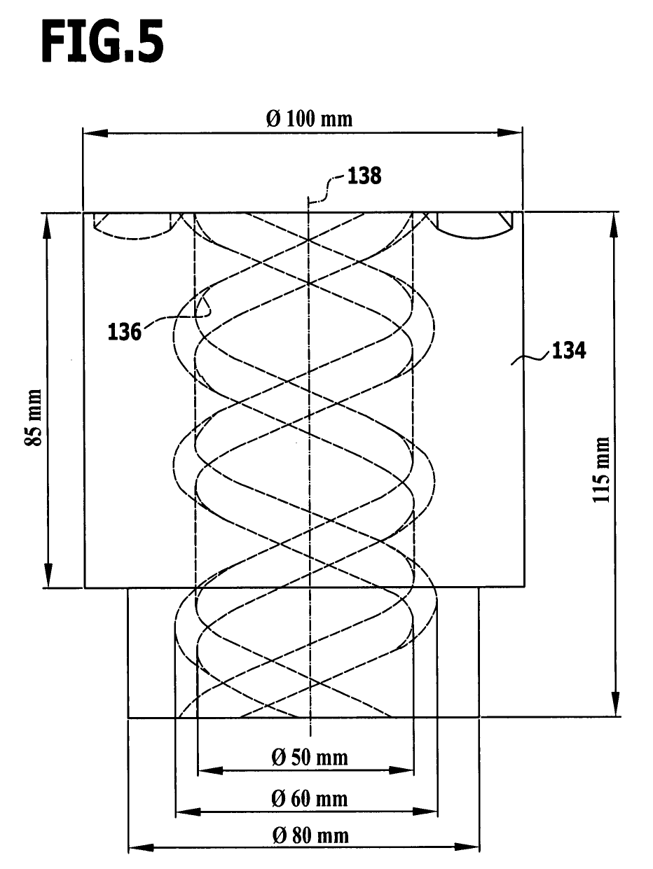

FIG. 5 is a developed view of the peripheral wall of the transport chamber from FIG. 4.

Identical or functionally equivalent elements have been given the same reference numerals in all figures.

A device, shown in FIGS. 1 to 5 and given the overall reference 100, for producing a flowable powder of a fluoropolymer from a starting material in powder form, which contains at least one fluoropolymer material, comprises a pressing device 102 with a pair of rollers 104, which are mounted to be rotatable around horizontal rotational axes 106 oriented parallel to one another and can be driven to perform a rotational movement around the rotational axes 106.

A roll gap 107 with a gap width b (see FIG. 2) of 1 cm, for example, and a gap length I (extent perpendicular to the plane of the drawing in FIG. 2) of 5 cm, for example, is configured between the rolling surfaces of the opposing rollers 104, so that the cross-sectional area of the roll gap amounts to 5 cm², for example.

The two rollers 104 rotate in opposite directions at the same roller speed, wherein the direction of rotation of the rollers is directed such that the rolling surfaces of the rollers move downwards at the location of the roll gap 107.

The starting material in powder form to be pressed to form band-shaped lumps by means of the rollers 104 is fed to the roll gap 107 by means of a worm device 108, the vertical rotational axis 110 of which runs substantially centrally through the roll gap 107.

The worm device 108 has a pitch that decreases in the vertically downwardly directed transport direction 112 and a diameter that decreases in the transport direction 112.

The worm device 108 is arranged in a downwardly tapering storage hopper 114, which merges at its lower end into a cylindrical transport chamber 130, which terminates at the rolling surfaces of the rollers 104.

The storage hopper 114 is closed at the top except for a filling opening.

A wide-mesh grating arranged on the filling opening prevents an operator from unintentionally accessing the worm device 108.

The starting material to be pressed is fed through the upper open end of the storage hopper by means of a scoop and is apportioned to the roll gap 107 by means of the vertically arranged worm device 108.

In this case, the worm shaft extends into the wedge-like region between the rolling surfaces of the rollers 104.

To assist the feeding action of the worm device 108, the cylindrical transport chamber 130 shown in detail in FIGS. 3 and 4 is provided on its inner peripheral wall 134 with a spiral-shaped groove 136, which extends in several turns in the same direction of rotation as the worm device 108 around the longitudinal axis 138 of the transport chamber 130.

In the developed view of the peripheral wall of the transport chamber 130 shown in FIG. 5, two such grooves 136 with opposing directions of rotation are shown, which can be selectively provided in dependence on the direction of rotation of the worm device 108.

Alternatively to this, a transport chamber with a smooth inner peripheral wall can also be used.

The pre-compacted and partially deaerated starting material is pressed by the rollers 104 to form the band-shaped lumps, which then pass into a screen-type mill 116 arranged below the pressing device 102.

The screen-type mill 116 shown in detail in FIG. 3 comprises a curved grinding plate 118, which is provided with holes 119 with diameters in the range of approximately 1 mm to approximately 6 mm.

In the interior 120 of the screen-type mill 116 surrounded by the grinding plate 118 a rotor 122 with five blades 124, for example, rotates around a horizontal rotational axis 126.

The rotor 122 is operated at a speed in the range of approximately 60 rpm to approximately 400 rpm.

The lumps produced by means of the pressing device 102 pass through an inlet 128 into the interior 120 of the screen-type mill 116 and are ground there to a flowable powder by the rotor 122 and the grinding plate 118.

This flowable powder passes through the holes in the grinding plate 118 out of the screen-type mill 116 and is collected in a collection tank (not shown).

From the collection tank the flowable powder is passed on for its further use, e.g. for the ram extrusion of polymer workpieces.

Several examples of a method for the production of a flowable powder of a fluoropolymer from a starting material in powder form conducted by means of the above-described device 100 are described below.

The PHARMAPAKTOR L200/50 P of Hosokawa Bepex GmbH, Daimlerstrape 8, 74211 Leingarten, Germany is used as pressing device 102 in all these examples.

The Pharmapaktor is equipped with smooth rollers with a slight transverse fluting.

The pre-compaction is performed with a cylindrical/conical pre-compactor worm device.

Two longitudinal rods are welded into the compactor hopper. Grooves running in a spiral shape around the direction of passage of the starting material can be milled into the inside of the compactor chamber.

The width b of the roll gap 107 amounts to 1 cm in all examples, the length l of the roll gap 107 respectively amounting to 5 cm, so that the cross-sectional area of the roll gap 107 respectively amounts to 5 cm².

In addition, screen mill FC 200 of Hosokawa Bepex GmbH, Daimlerstraβe 8, 74211 Leingarten, Germany is used in these examples as screen-type mill.

### EXAMPLE 1

The finely ground PTFE powder of the type TF 1750, which is marketed by Dyneon GmbH & Co KG, Werk Gendorf, 84504 Burgkirchen, Germany, is used as starting material in powder form. This is a PTFE powder produced using the suspension polymerisation process that has been ground by means of an air jet mill to an average grain diameter of d₅₀ of 25 μm.

The bulk density of the starting material used amounts to 370 g/l.

This starting material is fed into the storage hopper 114 by means of a scoop and conveyed into the roll gap 107 by means of the worm device 108.

The worm device 108 has the worm parameters 60; 64/100 mm, which means that the pitch of the worm device (distance from spiral to spiral) amounts to 60 mm, that the outside diameter of the worm device 108 in its lower cylindrical portion amounts to 64 mm, and that this outside diameter widens to 100 mm in the upper conical portion of the worm device 108.

This worm device 108 is operated at a worm speed of 18 rpm, a worm load current of 1.3 A and with a throughput of 110 kg/hr.

The starting material is pressed between the rollers 104 to form band-shaped lumps.

The rollers 104 are operated at a specific contact force of 3 kN/cm, a roller speed of 4 rpm and a roller load current of 3.0 A.

One of the rollers used has a concavely curved rolling surface, the other of the used rollers has a smooth-cylindrical rolling surface.

The lumps obtained are ground in the screen-type mill 116 to form a flowable powder with an average grain size of d₅₀ of 700 μm and a bulk density of approximately 800 g/l.

The powder obtained has a good flowability and can be easily apportioned by automatic devices for further processing.

### EXAMPLE 2

This exemplary embodiment only differs from Example 1 in that the specific contact force of the rollers is lowered to 2 kN/cm and the roller speed is increased to 6 rpm.

The throughput of the worm device is increased to 150 kg/hr in this case.

A powder with good flowability also results with this exemplary embodiment.

### EXAMPLE 3

This exemplary embodiment differs from Example 1 in that the rollers used are provided with a corrugation profile of 6 mm open to the side.

These rollers are operated at a specific contact force of 5 kN/cm at a roller speed of 5 rpm and a roller load current of 3.0 A.

The worm device used in this exemplary embodiment has the worm parameters 60/66/120 mm, i.e. a pitch of 60 mm, and an outside diameter, which amounts to 66 mm in the cylindrical portion and widens to 120 mm in the conical portion.

This worm device is operated at a worm speed of 18 rpm with a worm load current of 1.3 A and a throughput of 130 kg/hr.

A powder with good flowability is also obtained with this exemplary embodiment.

### EXAMPLE 4

In this exemplary embodiment the finely ground PTFE powder of the type NXT 75, which is marketed by DuPont de Nemours (Deutschland) GmbH, Bad Homburg, is used as starting material in powder form. This is a chemically modified PTFE produced using the suspension polymerisation process that has been ground by means of an air jet mill to a powder with an average grain diameter d₅₀ of 33 μm.

The bulk density of the starting material used amounts to 440 g/l.

One of the rollers used has a concavely curved rolling surface, the other of the used rollers has a smooth-cylindrical rolling surface.

The rollers 104 are operated at a specific contact force of 3 kN/cm, a roller speed of 4 rpm and a roller load current of 3.5 A.

The worm device used has the worm parameters 60/64/100 mm, which means that the pitch of the worm device (distance from spiral to spiral) amounts to 60 mm, that the outside diameter of the worm device 108 in the lower cylindrical portion amounts to 64 mm, and that this outside diameter widens to 100 mm in the upper conical portion of the worm device 108.

This worm device is operated at a worm speed of 18 rpm, a worm load current of 1.4 A and with a throughput of 120 kg/hr.

Otherwise, this exemplary embodiment is the same as Example 1.

A powder with good flowability is also obtained with this exemplary embodiment.

### EXAMPLE 5

This exemplary embodiment differs from Example 4 in that the rollers are operated at a specific contact force of 2 kN/cm, a roller speed of 6 rpm and a roller load current of 3.5 A.

The throughput of the worm device is increased to 170 kg/hr in this case.

A powder with good flowability is also obtained with this exemplary embodiment.

### EXAMPLE 6

This exemplary embodiment differs from Example 4 in that the rollers used are provided with a corrugation profile of 6 mm open to the side.

These rollers are operated at a specific contact force of 5 kN/cm at a roller speed of 5 rpm and a roller load current of 3.5 A.

The worm device used has the worm parameters 60/66/120 mm, i.e. a pitch of 60 mm, and an outside diameter, which amounts to 66 mm in the cylindrical portion and widens to 120 mm in the conical portion.

This worm device is operated at a worm speed of 18 rpm with a worm load current of 1.4 A and a throughput of 145 kg/hr.

A powder with good flowability is also obtained with this exemplary embodiment.

1. Method for the production of a flowable powder of a fluoropolymer from a starting material in powder form, which contains at least one fluoropolymer material, comprising the following method steps:
pressing the starting material in powder form into lumps;
crushing the lumps to form the flowable powder.

2. Method according to claim 1, wherein the starting material contains polytetrafluoroethylene or modified polytetrafluoroethylene as fluoropolymer material.

3. Method according to claim 1, wherein the starting material in powder form has a bulk density of approximately 100 g/l to approximately 700 g/l.

4. Method according to claim 1, wherein the flowable powder has a bulk density of approximately 400 g/l to approximately 1600 g/l.

5. Method according to claim 1, wherein the flowable powder has a higher bulk density than the starting material in powder form.

6. Method according to claim 1, wherein the fluoropolymer material of the starting material in powder form has an average grain size d₅₀ of approximately 5 μm to approximately 100 μm.

7. Method according to claim 1, wherein the flowable powder has an average grain size d₅₀ of approximately 300 μm to approximately 2500 μm.

8. Method according to claim 1, wherein the flowable powder has a higher average grain size d₅₀ than the fluoropolymer material in the starting material in powder form.

9. Method according to claim 1, wherein the starting material is conveyed by means of a worm device to a pressing device.

10. Method according to claim 9, wherein the pressing device has two opposing rollers and the worm device reaches into the wedge-like region between the opposing rollers.

11. Method according to claim 9, wherein the worm device has a substantially vertical rotational axis.

12. Method according to claim 9, wherein the worm device is operated at a speed of approximately 10 rpm to approximately 100 rpm.

13. Method according to claim 9, wherein the worm device has a pitch that decreases in the transport direction of the worm device.

14. Method according to claim 9, wherein the worm device has a diameter that decreases in the transport direction of the worm device.

15. Method according to claim 9, wherein the worm device is arranged in a transport chamber, which has at least one groove running in a spiral shape around the transport direction of the worm device.

16. Method according to claim 1, wherein the starting material in powder form is pre-compacted before pressing.

17. Method according to claim 1, wherein the starting material is at least partially deaerated before pressing.

18. Method according to claim 1, wherein the starting material is pressed to form the lumps by means of at least one roller.

19. Method according to claim 18, wherein the roller is operated with a specific contact force of approximately 1 kN/cm to approximately 10 kN/cm.

20. Method according to claim 18, wherein the roller is operated at a speed of approximately 3 rpm to approximately 10 rpm.

21. Method according to claim 18, wherein the roller is provided with a profiled rolling surface.

22. Method according to claim 1, wherein the relative density of the lumps produced by pressing the starting material amounts to approximately 1.3 g/cm³ to approximately 2.1 g/cm³.

23. Method according to claim 1, wherein the lumps are crushed by means of a mill.

24. Method according to claim 23, wherein the lumps are crushed by means of a screen-type mill.

25. Method according to claim 23, wherein the mill is operated at a speed of approximately 60 rpm to approximately 400 rpm.

26. Flowable powder of a fluoropolymer, which is produced by a method according to claim 1.

27. Use of a flowable powder according to claim 26 for the production of polymer workpieces by means of ram extrusion.

28. Polymer workpiece, which is produced from a flowable powder according to claim 26.
